(19) United States
(12) Patent Application Publication
(10) Pub. No.: US 2018/0007217 A1
(43) Pub. Date: Jan. 4, 2018

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Taro YOSHIHAMA, Kanagawa (JP)

(73) Assignee: FUJI XEROX CO., LTD., Tokyo (JP)

(21) Appl. No.: 15/439,255

(22) Filed: Feb. 22, 2017

(30) Foreign Application Priority Data
Jul. 1, 2016 (JP) 2016-131462

(51) Int. Cl. H04N 1/00; G06Q 30/06; H04N 1/21

(52) U.S. Cl. CPC H04N 1/00244; H04N 1/2166; G06Q 30/0635; H04N 2201/0094; H04N 2201/0093

(57) ABSTRACT

An information processing apparatus includes a memory, a reception unit, a specification unit, and a store creating unit. The memory stores an operation history of processes performed on a document. The reception unit receives selection of at least one operation from the operation history stored in the memory. The specification unit specifies associated information associated with the operation received by the reception unit. The store creating unit creates a store which contains operation information about the operation and which also contains the associated information. The operation is received by the reception unit. The associated information is specified by the specification unit.

### CROSS-REFERENCE TO RELATED APPLICATIONS

This application is based on and claims priority under 35 USC 119 from Japanese Patent Application No. 2016-131462 filed Jul. 1, 2016.

### BACKGROUND

### Technical Field

The present invention relates to an information processing apparatus, an information processing method, and a non-transitory computer readable medium.

### SUMMARY

According to an aspect of the invention, there is provided an information processing apparatus including a memory, a reception unit, a specification unit, and a store creating unit. The memory stores an operation history of processes performed on a document. The reception unit receives selection of at least one operation from the operation history stored in the memory. The specification unit specifies associated information associated with the operation received by the reception unit. The store creating unit creates a store which contains operation information about the operation and which also contains the associated information. The operation is received by the reception unit. The associated information is specified by the specification unit.

### BRIEF DESCRIPTION OF THE DRAWINGS

Exemplary embodiment of the present invention will be described in detail based on the following figures, wherein:

FIG. 1 is a diagram illustrating the configuration of an information processing system according to an exemplary embodiment of the present invention;

FIG. 2 is a block diagram illustrating the hardware configuration of an information processing apparatus according to the exemplary embodiment of the present invention;

FIG. 3 is a block diagram illustrating the functional configuration of the information processing apparatus according to the exemplary embodiment of the present invention;

FIG. 4 is a diagram for describing a data store according to the exemplary embodiment of the present invention;

FIG. 5 is a diagram illustrating an exemplary display screen displayed when a data store is unpacked, according to the exemplary embodiment of the present invention;

FIG. 6 is a diagram for describing operations performed by using the information processing apparatus according to the exemplary embodiment of the present invention;

FIG. 7 is a diagram illustrating exemplary operation-associated information according to the exemplary embodiment of the present invention;

FIG. 8 is a flowchart for describing operations performed by the information processing apparatus according to the exemplary embodiment of the present invention;

FIG. 9 is a diagram illustrating an exemplary display screen displayed when a data store is to be created, according to the exemplary embodiment of the present invention;

FIG. 10 is a flowchart for describing operations performed by the information processing apparatus according to the exemplary embodiment of the present invention; and

FIG. 11 is a diagram illustrating another exemplary display screen displayed when a data store is unpacked, according to the exemplary embodiment of the present invention.

### DETAILED DESCRIPTION

An exemplary embodiment of the present invention will be described in detail with reference to the drawings.

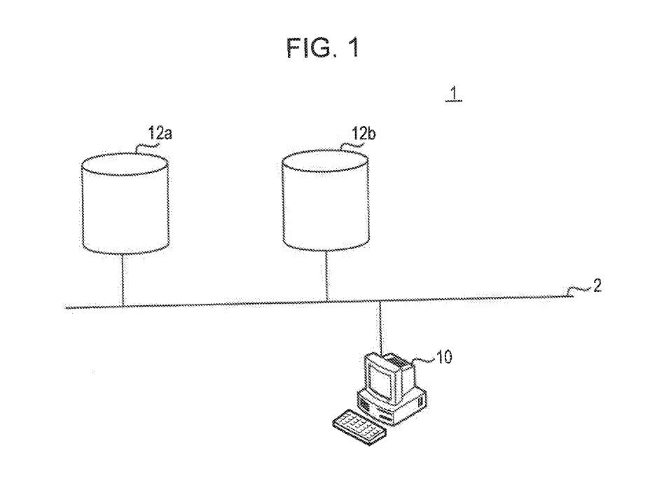

FIG. 1 is a diagram illustrating the system configuration of an information processing system 1 according to the exemplary embodiment of the present invention.

As illustrated in FIG. 1, the information processing system 1 according to the exemplary embodiment of the present invention includes an information processing apparatus 10 such as a personal computer and multiple core systems 12a and 12b, which are connected to one another through a network 2.

The core systems 12a and 12b store logic (e.g., document files, graphic files, operation manuals, associated documents, patterns, and necessary tools) necessary to perform tasks, and also store data, such as screens for input and reference for the logic, user input values for each task, calculation results from the logic, and status data indicating the state of software. The core systems 12a and 12b are also provided with interfaces (IFs) for direct reference or update from the information processing apparatus 10.

The information processing apparatus 10 which includes access information about access to the core systems 12a and 12b is capable of accessing each core system 12 so as to obtain data and the like necessary to perform a task. In addition, document-editing software is installed in the information processing apparatus 10. Data necessary to perform tasks needed to be performed by a user by using the document-editing software may be obtained from the core systems 12a and 12b. Thus, creation of a data store 14 that serves as a store and that is described below, editing and creation of document data, and reference to reference material serving as reference data may be performed.

That is, the information processing apparatus 10 is capable of receiving/transmitting data, a data store 14 storing data, and the like, from/to the core systems 12a and 12b and other information processing apparatuses.

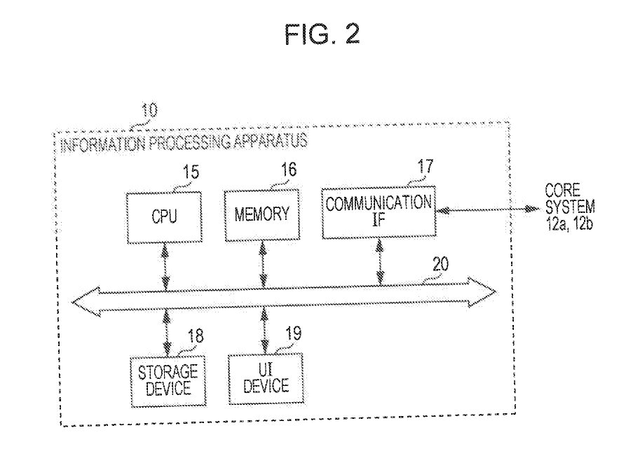

FIG. 2 illustrates the hardware configuration of the information processing apparatus 10 in the information processing system 1 according to the exemplary embodiment of the present invention.

As illustrated in FIG. 2, the information processing apparatus 10 includes a central processing unit (CPU) 15, a memory 16, a communication IF 17 which receives/transmits data from/to external apparatuses and the like over the network 2, a storage device 18 such as a hard disk drive (HDD), and a user interface (UI) device 19 including a touch panel or a liquid crystal display and a keyboard. These components are connected to one another through a control bus 20.

The CPU 15 performs given processes on the basis of control programs stored in the memory 16 or the storage device 18, and controls operations of the information processing apparatus 10. In the exemplary embodiment, the description is made under the assumption that the CPU 15 reads the control programs stored in the memory 16 or the storage device 18 for execution. The programs may be provided to the CPU 15 by storing the programs in a storage medium such as a compact disc-read-only memory (CD-ROM).

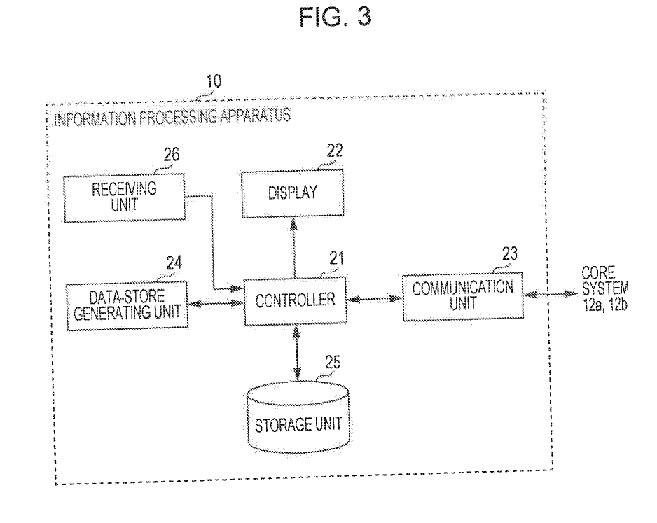

FIG. 3 is a block diagram illustrating the functional configuration of the information processing apparatus 10 which is implemented by executing the control programs.

As illustrated in FIG. 3, the information processing apparatus 10 according to the exemplary embodiment includes a controller 21, a display 22, a communication unit 23, a data-store generating unit 24, a storage unit 25, and a receiving unit 26.

The receiving unit 26 receives specification of an operation that serves as a starting point among a series of operations, and receives specification of associated information, such as document data, reference data, and web pages, that is associated with the operation. Thus, a series of operations necessary for a task may be narrowed.

The storage unit 25 stores an operation history describing a series of operations. In addition, the storage unit 25 stores operation information in the operation history describing a series of operations, in association with associated information, such as document data, reference data, and web pages, that has been used in the operation.

The display 22 displays the operation history describing a series of operations, operation information of these operations, associated information associated with the operation information, and the like under control exerted by the controller 21.

Under control exerted by the controller 21, the communication unit 23 communicates with the core systems 12a and 12b, and obtains associated information associated with operation information received by the receiving unit 26, through reception/transmission from/to the core systems 12a and 12b.

The controller 21 controls the display 22. Though the control, multiple pieces of operation information and associated information are displayed on the display 22 so that a user may select data that is to be stored in a data store 14, from among the pieces of information.

Under control exerted by the controller 21, the data-store generating unit 24 packs, into a single file as a data store 14, pieces of data, such as the operation information in the operation history that describes a series of operations and that is stored in the storage unit 25, the associated information associated with the operation information, and the access information about access to the core systems 12, and creates (outputs) the data store 14.

The controller 21 exerts control so that, by unpacking the data store 14, the operation information in the operation history describing a series of operations, associated information associated with the operation information, and the like which are stored in the data store 14 are displayed on the display 22.

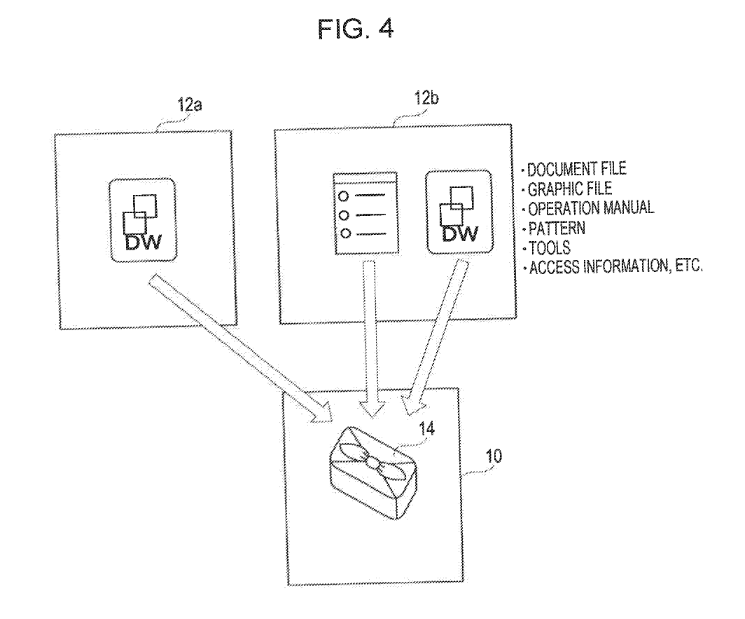

The data store 14 will be described in detail on the basis of FIG. 4.

The data store 14 is such that multiple pieces of data of various data formats, such as document files (document data), graphic files (graphic data), operation manuals, associated documents, patterns, necessary tools, and access information about access to the core systems 12 (such as uniform resource locators (URLs) and user information), are packed into a single file for transport. That is, the data store 14 in which multiple pieces of data are stored may be received/transmitted from/to the core systems 12a and 12b and other information processing apparatuses over the network 2.

In the exemplary embodiment, the information processing apparatus 10 obtains data that is stored in the core system 12a or 12b and that describes a series of operations, stores the obtained data, creates a data store 14, and unpacks the data store 14. Thus, methods or procedures for operating the core systems are displayed together on the information processing apparatus 10. A user may efficiently perform a task by performing operations according to the information displayed on the display screen.

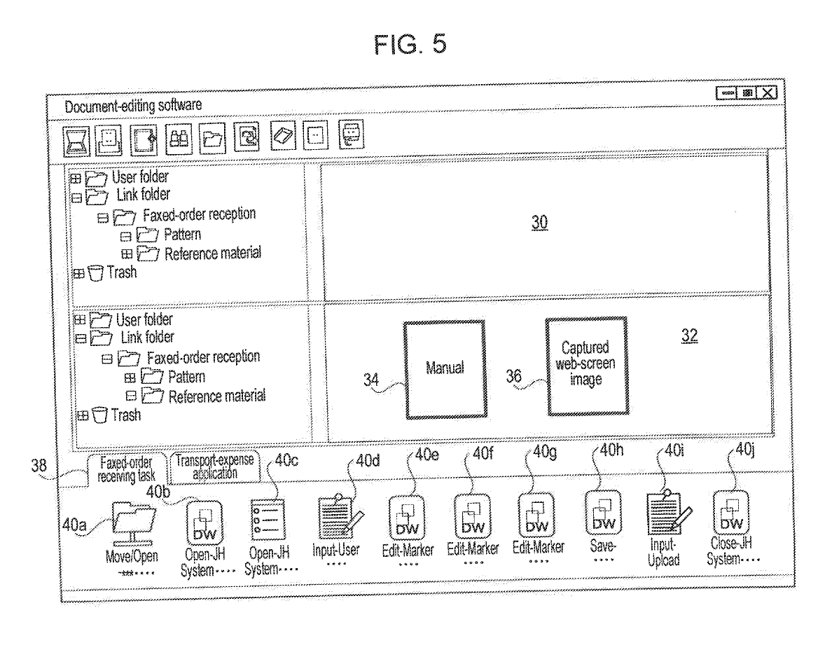

An example in which the information processing apparatus 10 unpacks a data store 14 will be described in detail. When the data store 14 is unpacked, the document-editing software is activated. For example, a display screen as illustrated in FIG. 5 is displayed on the display 22. In this example, a detailed description will be made by taking a faxed-order receiving task as an example.

A faxed-order reception folder is created in a tree in a link folder. A pattern folder and a reference-material folder are created as subfolders of the faxed-order reception folder. Data in the pattern folder is displayed on an upper workspace 30, and data in the reference-material folder is displayed on a lower workspace 32. That is, in the exemplary display screen illustrated in FIG. 5, it is seen that no data is present in the pattern folder, and a manual 34 and a captured web-screen image 36 are stored in the reference-material folder. Through clicking of data displayed on the workspaces 30 and 32, enlargement of the display, checking of the information, and editing such as an input operation may be performed.

A tab of “Faxed-order receiving task” that is the name of the data store 14 is created in a tool bar 38. Icons for pieces of data 40 that are data 40a to 40j are displayed in such a manner as to be arranged in chronological order. That is, the icons for the pieces of data 40 which are arranged in the tool bar 38 are activated from the left, i.e., from the data 40a to the data 40j in this order, so that a series of operations may be completed.

That is, even when a user does not remember the sequence of a series of operations, the user may know which operation is to be performed among the series of operations. The user may click the icon for one of the pieces of data 40 to display documents, patterns, and reference material which are associated with the operation. Thus, the user may perform an operation while checking the manual 34 and the captured web-screen image 36. The captured web-screen image 36 may receive character input with coordinates or the like of the display screen. Thus, the captured web-screen image 36 may receive input even in the offline state, achieving efficiency of an operation.

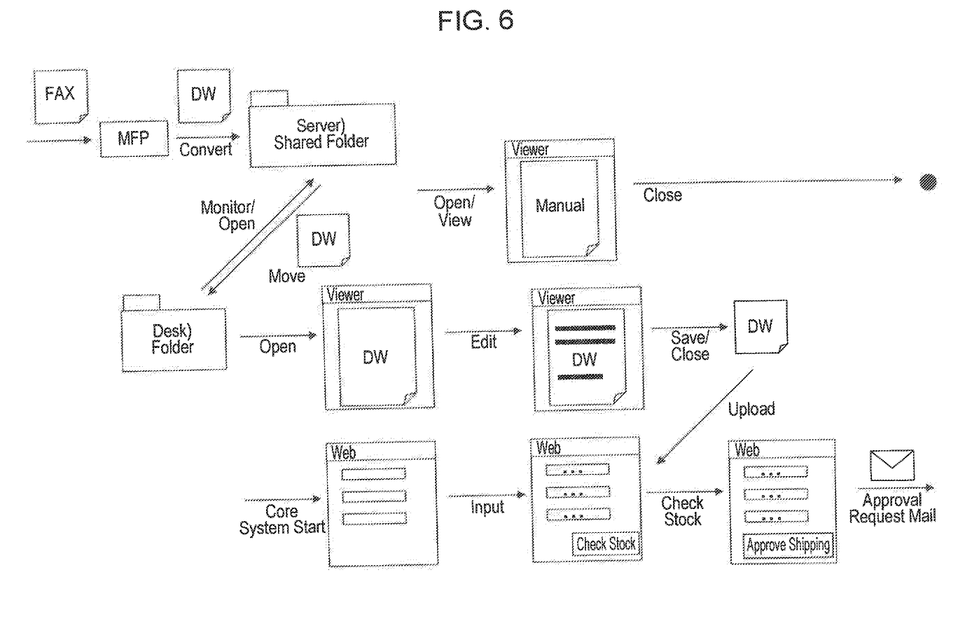

An operation in which the information processing apparatus 10 creates a data store 14 will be described in detail with reference to FIGS. 6 to 9 by taking the faxed-order receiving task as an example.

Operations in the faxed-order receiving task which are performed by the information processing apparatus 10 will be briefly described on the basis of FIG. 6.

As illustrated in FIG. 6, a fax received by using a multi-function printer (MFP) is converted into a DocuWorks (DW) document, and the resulting document is stored in a shared folder of a server.

The information processing apparatus 10 monitors the shared folder. The information processing apparatus 10 moves the DW document that corresponds to the fax and that is present in the shared folder of the server, to a local folder, and opens the DW document (fax) that has been moved to the local folder.

A core system 12 for order-taking/placing is activated. While the order information described by the fax is checked, necessary items are filled in through writing or selection in the core system 12.

An operation manual of the core system is opened and checked. After checking, the operation manual is closed.

The DW document (fax) that has been edited, for example, by using tags, with information which has been input in the core system is stored in a terminal (information processing apparatus 10).

The DW document (fax) is uploaded to the core system 12 to perform stock-checking in the core system. When it is determined that the ordered product is carried in stock, the core system transmits a request for approval of shipping (mail transmission).

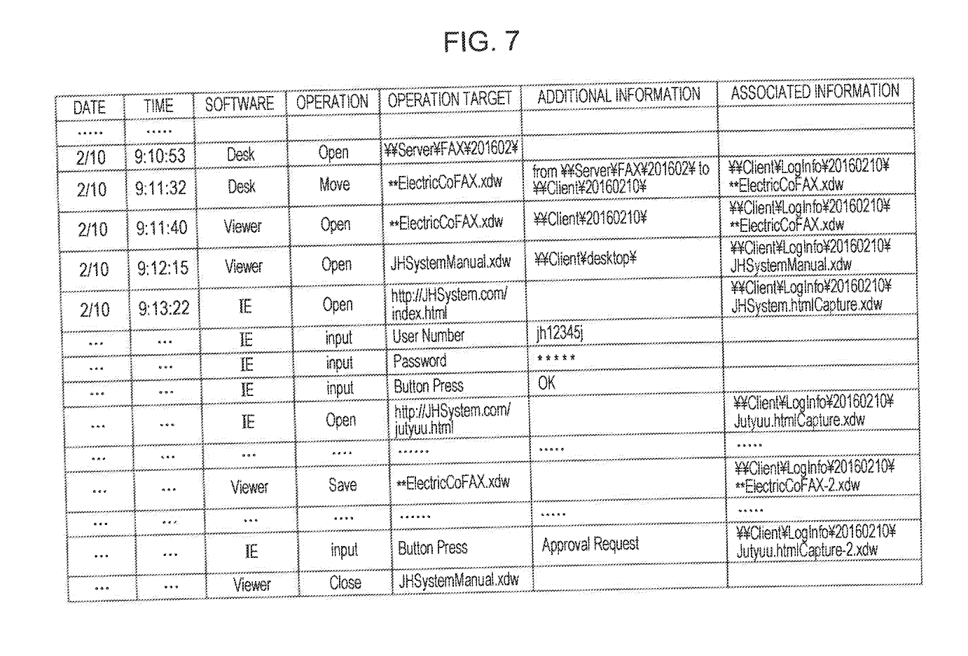

FIG. 7 illustrates exemplary operation information (log information) in the above-described faxed-order receiving task.

The pieces of data 40, which serve as operation information and each of which is obtained by associating pieces of information with one another, such as the date, the time, the software, the operation, the operation target, additional information, and associated information for execution of each operation (data), are stored in the storage unit 25 as an operation history.

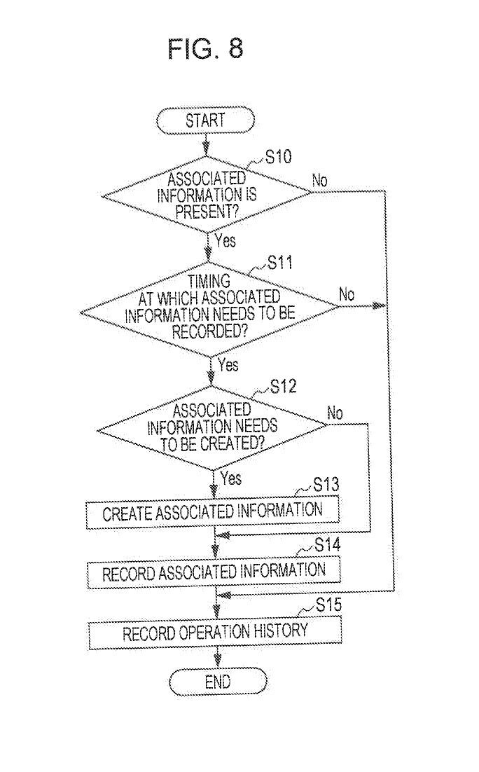

FIG. 8 is a flowchart illustrating operations performed when the information processing apparatus 10 specifies associated information.

### Step S10

It is determined whether or not associated information associated with the operation information for a selected operation is present. Exemplary associated information includes document data which has been used in an operation that has been performed before, reference data that has been referred to, and web pages. If it is determined that associated information is present, the process proceeds to the next step S11. If it is determined that associated information is not present, the process proceeds to the next step S15.

### Step S11

It is determined whether or not this is a timing at which associated information needs to be recorded. Specifically, it is determined whether or not the user operation is a given operation, such as “Open” or “Close” after execution of “Save” for document data when associated information is document data, or “Open” or “Press the OK button after specification of a URL” for a web page. In this way, it is determined whether or not this is a timing at which associated information needs to be recorded. If it is determined that this is a timing at which associated information needs to be recorded, the process proceeds to the next step S12. If it is determined that this is not a timing at which associated information needs to be recorded, the process proceeds to the next step S15.

### Step S12

It is determined whether or not associated information needs to be created. Specifically, when associated information is a web page, screen display information such as screen capture information needs to be created. If it is determined that screen display information which serves as associated information needs to be created, the process proceeds to the next step S13. If it is determined that screen display information does not need to be created, the process proceeds to the next step S14.

### Step S13

Associated information data such as screen capture information is created as associated information on the basis of a web page or the like.

### Step S14

The associated information is recorded in the storage unit 25.

That is, one operation is selected so that the information processing apparatus 10 automatically extracts the operation information about the selected operation and associated information associated with the operation information, and specifies and records a series of operations.

### Step S15

The operation history is recorded, and the process ends.

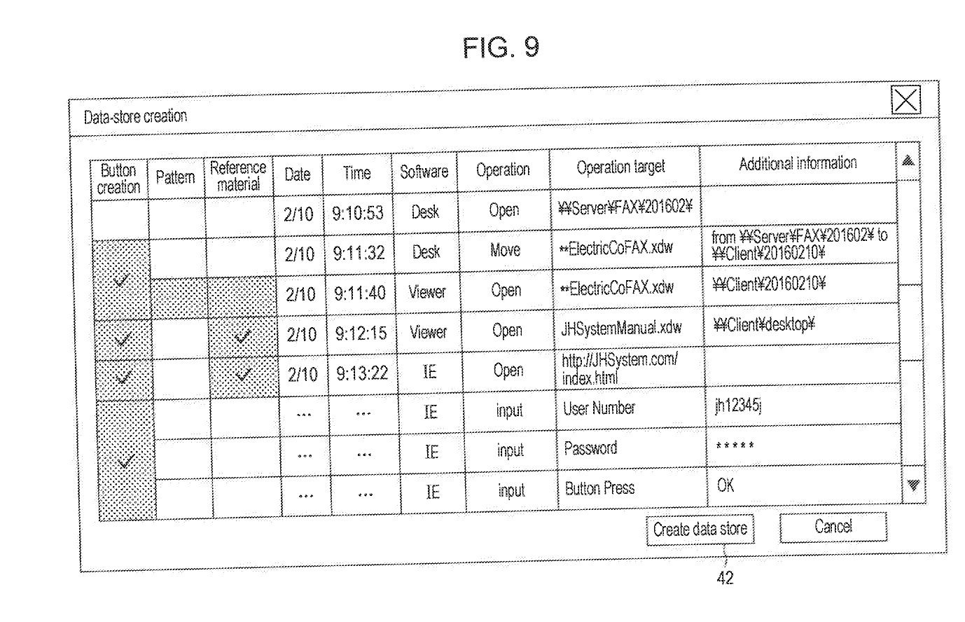

FIG. 9 is a diagram illustrating a data-store generation screen for generating a data store 14. As illustrated in FIG. 9, a user may further select data that is to be finally stored in a data store 14, from operation information selected on a display screen and associated information automatically extracted on the basis of the selected operation information when necessary, and may include the selected data in the data store 14.

A user may select “BUTTON CREATION”, “PATTERN”, and “REFERENCE MATERIAL” for each data (operation) which are displayed on the display screen in addition to the operation information, and may press a data-store generating button 42 so that the selected information may be included in the data store 14.

For example, when there is an operation (data) that is to be included in the pieces of data 40 in the tool bar 38 illustrated in FIG. 5, a user puts a checkmark in a cell for the operation that is to be subjected to “BUTTON CREATION”. A combination of some operations may be included in a single button. That is, an operation (data) for which a checkmark is put in the “BUTTON CREATION” cell on the data-store generation screen is created as a button, and may be added to a series of operations.

When data is to be used as a pattern, a checkmark is put in a cell for the data that is to be used as a “PATTERN”. As described below, a pattern and a document that has been edited and stored in a series of operations may be distinguished from each other, for example, by automatically determining whether data is a document created in the series of operations or a pattern, and by changing the color of the cell for the data. Introduction of a pattern prevents a document individually created by a user from being erroneously included in a data store 14.

When data is to be used as reference material, a checkmark is put in a cell for the data that is to be used as a “REFERENCE MATERIAL”. In addition, document data that has been viewed in a series of operations but that has been closed without being edited or stored, and document data created in the series of operations (after editing) may be included in a data store 14 as reference material. As described below, reference material that is automatically determined may be added to the data store 14.

Associated information (data) for which a checkmark is put in the cell of “PATTERN” on the data-store generation screen is stored in a pattern folder, and is displayed in the workspace 30. Further, associated information for which a checkmark is put in the cell of “REFERENCE MATERIAL” is stored in a reference-material folder, and is displayed in the workspace 32.

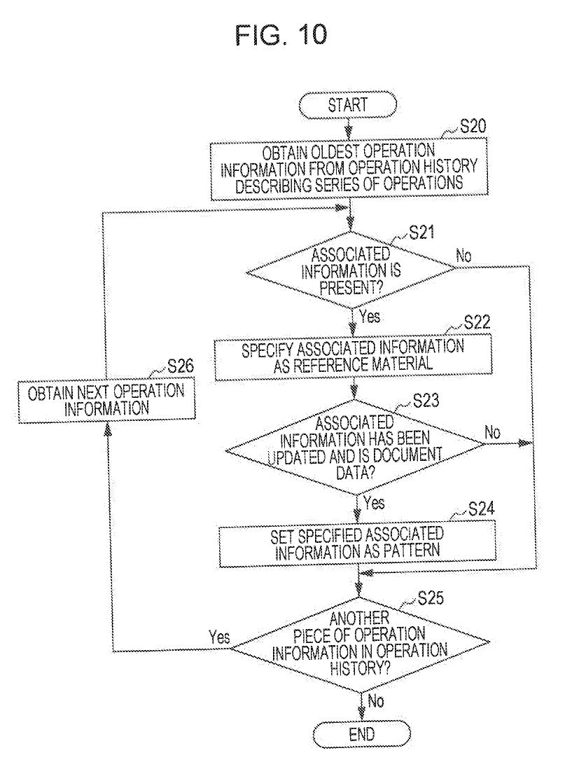

An operation in which the information processing apparatus 10 determines whether data is a pattern or reference material will be described in detail by referring to the flowchart in FIG. 10. The description will be made under the assumption that a pattern is document data before editing (before updating) and that reference material is document data that is not capable of being edited.

### Step S20

The oldest operation information is obtained from an operation history describing a series of operations.

### Step S21

It is determined whether or not associated information associated with the obtained operation information is present. If it is determined that associated information is present, the process proceeds to the next step S22. If it is determined that associated information is not present, the process proceeds to the next step S25.

### Step S22

Then, associated information is specified and used as reference material.

It is checked if the obtained information has been updated in the series of operations. If the obtained information has been updated, the reference-material cell for the updated data may be colored so that a user may put a checkmark so as to include the data in the data store 14.

### Step S23

Then, it is determined whether or not the specified associated information has been updated in the series of operations and is document data. If the specified associated information has been updated and is document data, the process proceeds to the next step S24. If the specified associated information has not been updated or is not document data, the process proceeds to the next step S25.

### Step S24

The specified associated information is set as a pattern.

When the information is a Portable Document Format (PDF) file or a DW document (such as a blank form document, a blank application, a form, or a template), the information is not set as a pattern in some cases. When the information is an Office document, the information is set as a pattern in many cases. When the information is a PDF file or a DW document, the pattern cell may be colored. When the information is an Office document, the pattern cell may be colored. Further, a user may put a checkmark so as to include the information in the data store 14.

### Step S25

It is determined whether or not another piece of operation information is present in the operation history describing a series of operations. If it is determined that another piece of operation information is not present, the process ends. If it is determined that another piece of operation information is present, the next piece of operation information is obtained (step S26), and the process returns back to step S21.

In the operation history describing a series of operations, data that has been changed (updated) is specified as document data, and data that has not been changed (has not been updated) may be specified as reference data. Alternatively, data before change (updating) may be specified as document data, and the data after change may be specified as reference data.

### Modified Example

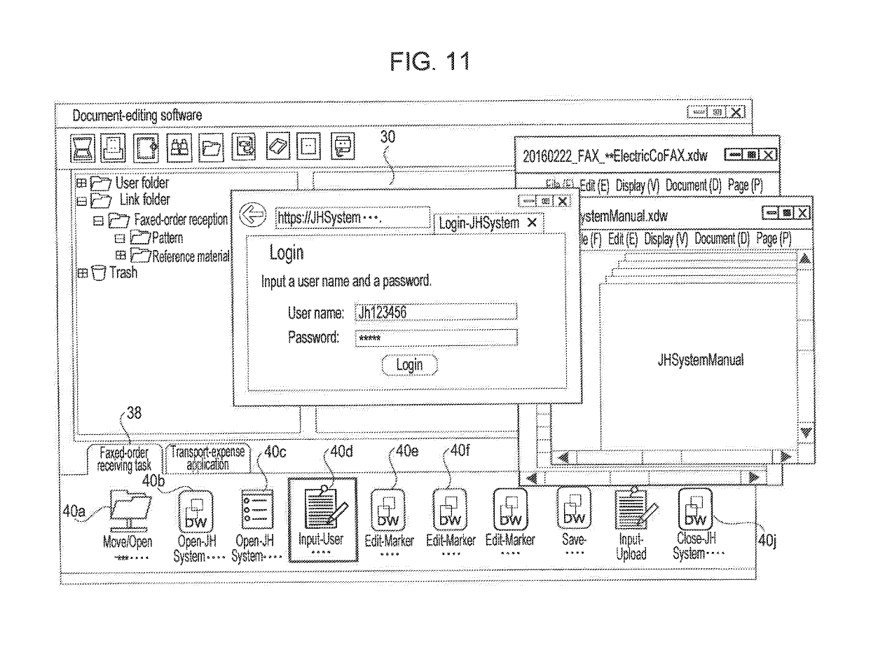

FIG. 11 is a diagram illustrating another exemplary display screen displayed with a data store 14 being unpacked, according to the exemplary embodiment of the present invention.

A faxed-order reception folder is created in a tree in the link folder. A pattern folder and a reference-material folder are created as subfolders of the faxed-order reception folder. Information stored in an opened folder is displayed on the workspace 30.

A tab of “Faxed-order receiving task” that is the name of the data store 14 is created in the tool bar 38. A series of operation information stored in the data store 14 are graphically displayed as icons for the pieces of data 40. The pieces of data 40 that are the data 40a to 40j are arranged from the left in chronological order. That is, the icons for the pieces of data 40 arranged in the tool bar 38 are activated from the left, i.e., from the data 40a to the data 40j in this order, so that the series of operations may be completed.

The icon for data that is being operated (the data 40d in FIG. 11) is covered with a frame, and pieces of information about operations are displayed on top of one another on the display screen in the order in which the operations have been performed. The configuration in which the icon for an operation that is being performed is covered with a frame is not limiting. The icon for an operation that is being performed may be displayed, for example, in such a manner as to be colored. That is, even if a user does not remember the sequence of a series of operations, the user may check an operation that is being performed, among the series of operations. For example, this may improve operability in execution of a task.

In the above-described exemplary embodiment, the case in which the present invention is applied to document-editing software is described. The present invention is not limited to this. The present invention may be applied similarly to software as long as the software has a configuration in which document data (document file), reference data, web data, and the like may be edited.

For example, the present invention may be applied not only to software for editing document data on a personal computer, but also similarly to software for editing document data on a portable information terminal or the like, such as a smartphone or a tablet terminal.

In the exemplary embodiment, the programs executed by the information processing apparatus may be provided by storing the programs in a computer-readable recording medium, such as a magnetic recording medium (such as a magnetic tape, a magnetic disk (a hard disk drive (HDD) or a flexible disk (FD))), an optical recording medium (a compact disk (CD) or a digital versatile disk (DVD))), a magneto-optical recording medium (such as an optical disk or a semiconductor memory (such as a flash read-only memory (ROM)). Alternatively, the programs may be downloaded via a network such as the Internet.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a memory that stores an operation history of processes performed on a document;
a reception unit that receives selection of at least one operation from the operation history stored in the memory;
a specification unit that specifies associated information associated with the operation received by the reception unit; and
a store creating unit that creates a store which contains operation information about the operation and which also contains the associated information, the operation being received by the reception unit, the associated information being specified by the specification unit.

2. The information processing apparatus according to claim 1,
wherein the associated information encompasses document data and reference data, the document data being data which is associated with the operation received by the reception unit and on which the operation is to be performed, the reference data being data that is associated with the received operation information and that is referred to when the operation is performed.

3. The information processing apparatus according to claim 1, further comprising:
a history display controller that exerts control in such a manner that the operation history of a series of operations is displayed; and
an associated-information display controller that exerts control in such a manner that the associated information associated with the operation information is displayed,
wherein the store creating unit creates information including selected operation information and selected associated information so as to store the created information in the store, the selected operation information being selected on a basis of the operation history displayed by the history display controller, the selected associated information being selected on a basis of the associated information displayed by the associated-information display controller.

4. The information processing apparatus according to claim 2, further comprising:
a history display controller that exerts control in such a manner that the operation history of a series of operations is displayed; and
an associated-information display controller that exerts control in such a manner that the associated information associated with the operation information is displayed,
wherein the store creating unit creates information including selected operation information and selected associated information so as to store the created information in the store, the selected operation information being selected on a basis of the operation history displayed by the history display controller, the selected associated information being selected on a basis of the associated information displayed by the associated-information display controller.

5. The information processing apparatus according to claim 3,
wherein the history display controller displays the operation history of a series of operations in chronological order.

6. The information processing apparatus according to claim 4,
wherein the history display controller displays the operation history of a series of operations in chronological order.

7. The information processing apparatus according to claim 3,
wherein the history display controller displays the operation history of a series of operations by using a plurality of pieces of graphic data.

8. The information processing apparatus according to claim 4,
wherein the history display controller displays the operation history of a series of operations by using a plurality of pieces of graphic data.

9. The information processing apparatus according to claim 5,
wherein the history display controller displays the operation history of a series of operations by using a plurality of pieces of graphic data.

10. The information processing apparatus according to claim 6,
wherein the history display controller displays the operation history of a series of operations by using a plurality of pieces of graphic data.

11. The information processing apparatus according to claim 2,
wherein, for the operation history of a series of operations, the specification unit specifies data that has been changed, as the document data, and specifies data that has not been changed, as the reference data.

12. The information processing apparatus according to claim 2,
wherein, for the operation history of a series of operations, the specification unit specifies data before change, as the document data, and specifies data after change, as the reference data.

13. The information processing apparatus according to claim 1, further comprising:
a display controller that exerts control in such a manner that the operation information and the associated information are displayed, the operation information and the associated information being contained in the store.

14. The information processing apparatus according to claim 13,
wherein the display controller exerts control in such a manner that the document data and the reference data are displayed, the document data and the reference data being encompassed in the associated information, the display being made in such a manner that the document data is distinguished from the reference data.

15. The information processing apparatus according to claim 14,
wherein the display controller exerts control in such a manner that, when data is changed from the document data to the reference data, the data is displayed as the reference data.

16. A non-transitory computer readable medium storing a program causing a computer to execute a process comprising:
storing an operation history of processes performed on a document;
receiving selection of at least one operation from the stored operation history;
specifying associated information associated with the received operation; and
creating a store which contains operation information about the received operation and which also contains the specified associated information.

17. An information processing method comprising:
storing an operation history of processes performed on a document;
receiving selection of at least one operation from the stored operation history;
specifying associated information associated with the received operation; and
creating a store which contains operation information about the received operation and which also contains the specified associated information.
